(19) United States
(12) Patent Application Publication
(10) Pub. No.: US 2025/0293810 A1
(43) Pub. Date: Sep. 18, 2025

(54) SYMBOL-LEVEL BASED LOG LIKELIHOOD RATIO (LLR) COMPANDING AND DECOMPANDING

(71) Applicant: QUALCOMM Incorporated, San Diego, CA (US)

(72) Inventors: Wei YANG, San Diego, CA (US); Jing JIANG, San Diego, CA (US); Jing SUN, San Diego, CA (US)

(21) Appl. No.: 18/606,951

(22) Filed: Mar. 15, 2024

(51) Int. Cl. H04L 1/1812; H04B 17/336; H04L 1/00; H04L 1/1829

(52) U.S. Cl. CPC H04L 1/1812; H04B 17/336; H04L 1/0003; H04L 1/1835

(57) ABSTRACT

Certain aspects of the present disclosure provide a method for wireless communications at a receiver device. The receiver device may receive packets including an initial transmission and at least one hybrid automatic repeat request (HARQ) retransmission. The receiver device may obtain log likelihood ratios (LLRs) for the packets. The receiver device may compand each LLR to generate at least one bit sign of each LLR. The receiver device may jointly decompand each subset of companded LLRs that are associated with a same modulation symbol using single bit signs corresponding to the subset of companded LLRs.

### BACKGROUND

### Field of the Disclosure

Aspects of the present disclosure relate to wireless communications, and more particularly, to techniques for symbol-based processing of log likelihood ratios (LLRs) of packets.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a receiver device. The method includes receiving packets comprising an initial transmission and at least one hybrid automatic repeat request (HARQ) retransmission; obtaining log likelihood ratios (LLRs) for the packets; companding each LLR to generate at least one bit sign of each LLR; and jointly decompanding each subset of companded LLRs that are associated with a same modulation symbol using single bit signs corresponding to the subset of companded LLRs.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example memory for storing hybrid automatic repeat request (HARQ) log likelihood ratio (LLR).

FIG. 6 depicts example graph illustrating LLR distribution of a signal received by a receiver device.

FIG. 7 depicts a call flow diagram illustrating example communication among a transmitter device and a receiver device for managing companding and decompanding of LLRs of packets.

FIG. 8 depicts example table showing mapping of bits to symbols.

FIG. 9 depicts example transition probability matrix.

FIG. 10 depicts example graph illustrating LLR distribution of different bits.

FIG. 11 depicts another example table showing mapping of bits to symbols.

FIG. 12 depicts example graph illustrating throughput distribution for different values of signal to noise ratios (SNRs) for a first set of parameters.

FIG. 13 depicts example graph illustrating throughput distribution for different values of SNRs for a second set of parameters.

FIG. 14 depicts example graph illustrating throughput distribution for different values of SNRs for a third set of parameters.

FIG. 15 depicts example graph illustrating throughput distribution for different values of SNRs for a fourth set of parameters.

FIG. 16 and FIG. 17 depict example graphs illustrating LLR distribution of a signal received by a receiver device.

FIG. 18 depicts a method for wireless communications by a receiver device for managing companding and decompanding of LLRs of packets.

FIG. 19 depicts aspects of example communications device managing companding and decompanding of LLRs of packets.

### DETAILED DESCRIPTION

Aspects of the present disclosure provide apparatuses, methods, processing systems, and computer-readable mediums for symbol-based processing (e.g., companding and/or decompanding) of log likelihood ratios (LLRs) of packets.

In wireless communications, hybrid automatic repeat request (HARQ) is a technique that is used to improve the reliability and efficiency of a data transmission. The HARQ is a feedback and retransmission mechanism that enables a receiver device to request retransmissions of lost or erroneous data packets. For example, a transmitter device sends a packet of data to the receiver device, which then checks the packet for errors. If the packet is received correctly, the receiver device sends an acknowledgement (ACK) back to the transmitter device to indicate that the data has been successfully received. However, if the packet contains errors, the receiver device sends a negative acknowledgement (NACK) back to the transmitter device, indicating that the packet needs to be retransmitted. The advantage of the HARQ is that it enables the receiver device to request retransmissions of only the data that was lost or corrupted, rather than requiring the entire packet to be resent. This reduces the amount of retransmitted data and improves the overall efficiency of a system.

The HARQ operation described above may discard erroneously received packets and request retransmission. The retransmission may represent a same set of information bits as an original transmission. However, a set of coded bits transmitted in each retransmission may be selected differently as long as they represent the same set of information bits. The HARQ with soft combining is therefore usually categorized into chase combining and incremental redundancy, depending on whether retransmitted bits are required to be identical to the original transmission or not.

In the chase combining, the retransmissions consist of the same set of coded bits as the original transmission. After each retransmission, the receiver device may use a maximum-ratio combination to combine each received channel bit with any previous transmissions of a same bit, and a combined signal is fed to a decoder. As each retransmission is an identical copy of the original transmission, the retransmissions with the chase combining can be seen as additional repetition coding.

In the incremental redundancy, each retransmission may not have to be identical to the original transmission. Instead, multiple sets of coded bits are generated, each representing the same set of information bits. Whenever the retransmission is required, the retransmission uses a different set of coded bits than a previous transmission. The receiver device combines the retransmission with previous transmission attempts of a same data packet. As the retransmission may contain additional parity bits not included in the previous transmission attempts, a resulting code rate may be lowered by the retransmission. Furthermore, each retransmission may not necessarily have to consist of the same number of coded bits as the original and, in general, a modulation scheme may also be different for different retransmissions.

In HARQ systems, data from previously received data packets may be stored in a buffer or memory (e.g., which may be at the receiver device). This data for buffered packets at the receiver device may be represented by quantizing log likelihood ratios (LLRs) of coded bits.

In some cases, for soft combining a large number of HARQ processes, the memory of a large size may be needed at the receiver device to store all HARQ LLRs. For example, the receiver device may offload the HARQ LLRs to the memory through a double date rate (DDR). In such cases, a bandwidth of the DDR may limit how much information can be stored per LLR.

In some cases, to reduce the buffer size and DDR bandwidth requirements, the HARQ LLRs may be excessively companded and then stored by the receiver device. For example, each HARQ LLR may be compressed to be one bit per HARQ LLR. The compressed HARQ LLR may later be decompanded. Companding may include quantizing (i.e., a process of mapping continuous infinite values to a smaller set of discrete finite values) and/or compressing of the HARQ LLRs. Decompanding may include dequantizing, decompressing, and/or reconstructing the compressed HARQ LLRs. In some cases, companding may refer to a technique for compressing and then expanding (or decompressing) an analog or digital signal. It is a combination of the words “compressing” and “expanding.”

When companding/decompanding of the HARQ LLRs may be performed using currently available methods, there may be a large performance loss (i.e., some loss of information) caused due to the excessive compression of the HARQ LLRs. Accordingly, new companding/decompanding techniques, which may use one bit per LLR but also achieve a high performance (i.e., reduced loss of information), are desirable.

The new techniques proposed herein may enable the receiver device to jointly reconstruct multiple LLRs (e.g., companded/compressed LLRs) that are associated with a same modulation symbol. For example, for the companding, the receiver device may only store signs of the LLRs (e.g., which results in one bit per LLR). For example, +3, +5, +7.3 etc. may all be compressed into 0, and −2, −18, etc. may all be compressed into 1. For the decompanding, the receiver device may reconstruct the multiple companded LLRs jointly that may be associated with the same modulation symbol based on the signs of these companded LLRs.

Particular aspects of the subject matter described in this disclosure can be implemented for the chase combining based HARQ and the incremental redundancy based HARQ to realize one or more of the following potential advantages. In some examples, the described techniques may improve overall performance of companding/decompanding operations (i.e., reduced loss of information during the companding/decompanding).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

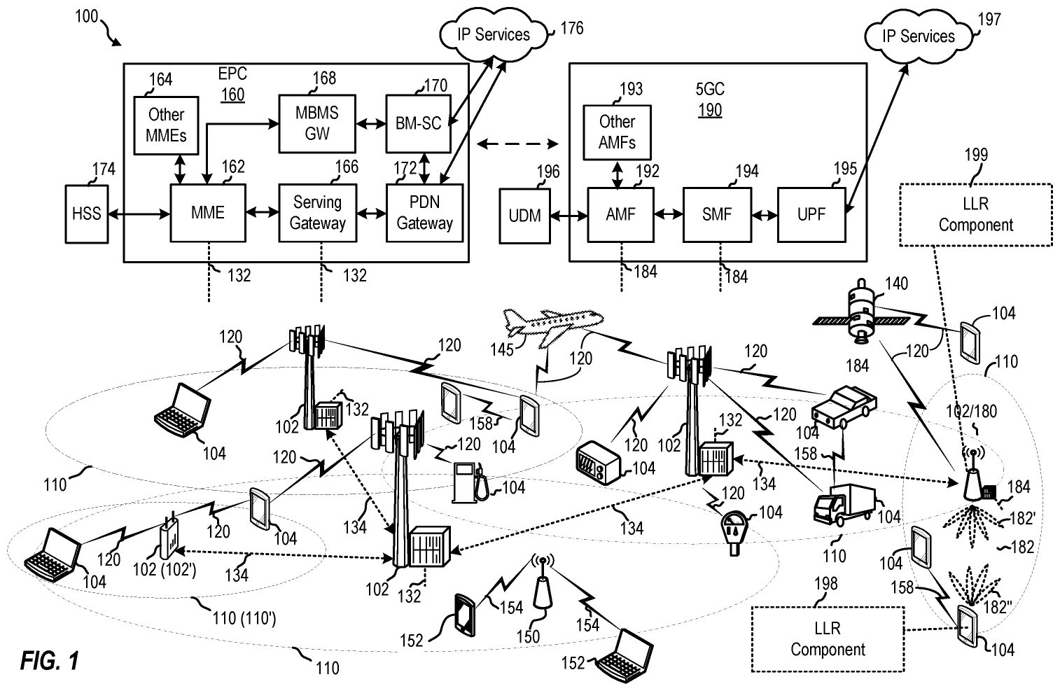

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

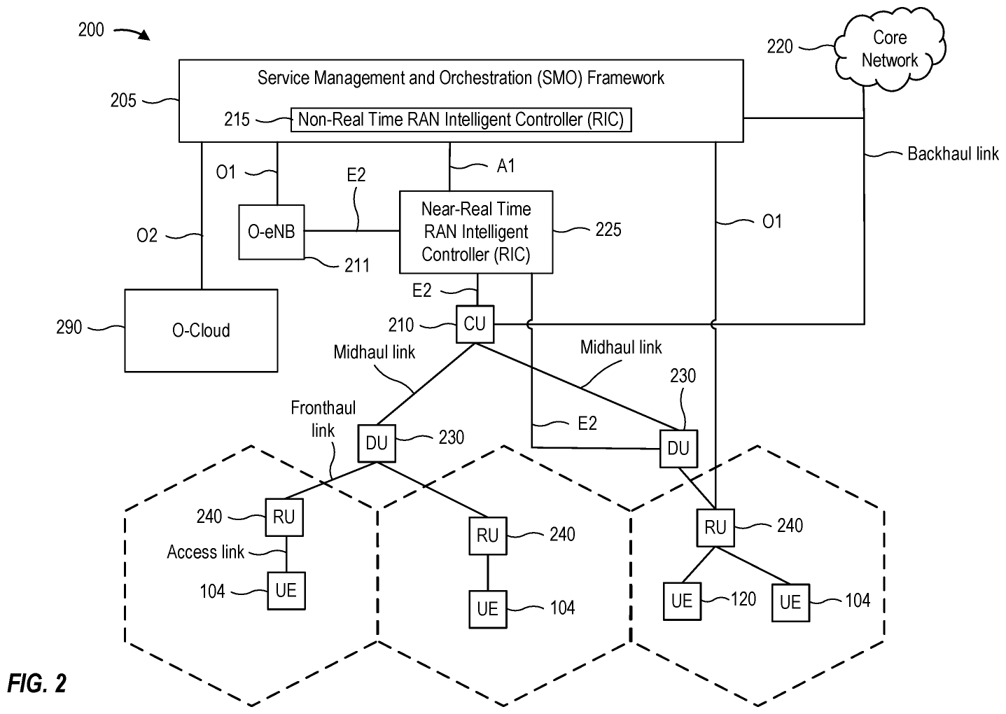

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

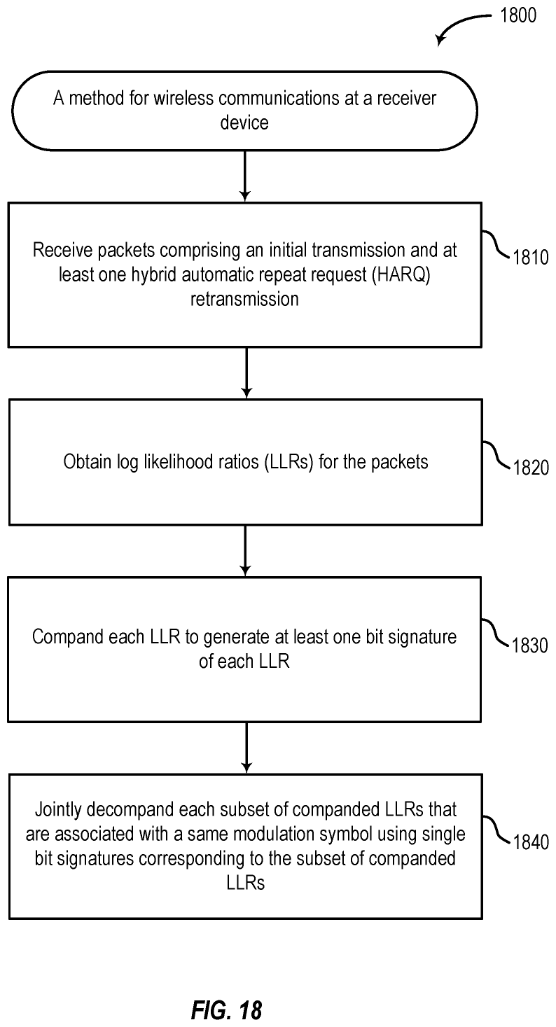

Wireless communication network 100 further includes likelihood ratio (LLR) component 198, which may be configured to perform method 1800 of FIG. 18. Wireless communication network 100 further includes LLR component 199, which may be configured to perform method 1800 of FIG. 18.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

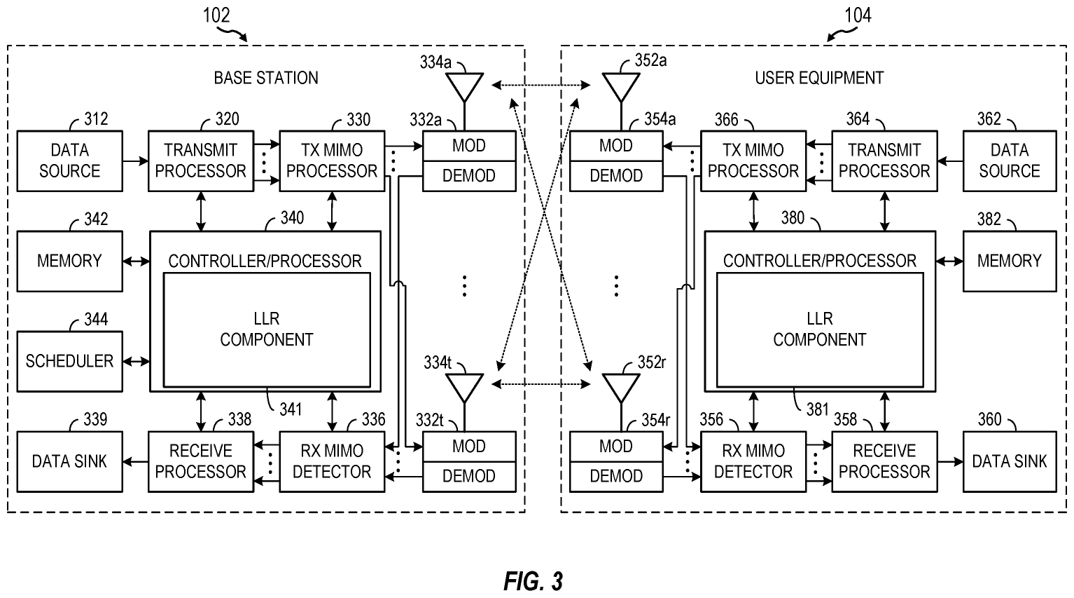

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes LLR component 341, which may be representative of LLR component 199 of FIG. 1. Notably, while depicted as an aspect of controller/processor 340, LLR component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes LLR component 381, which may be representative of LLR component 198 of FIG. 1. Notably, while depicted as an aspect of controller/processor 380, LLR component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

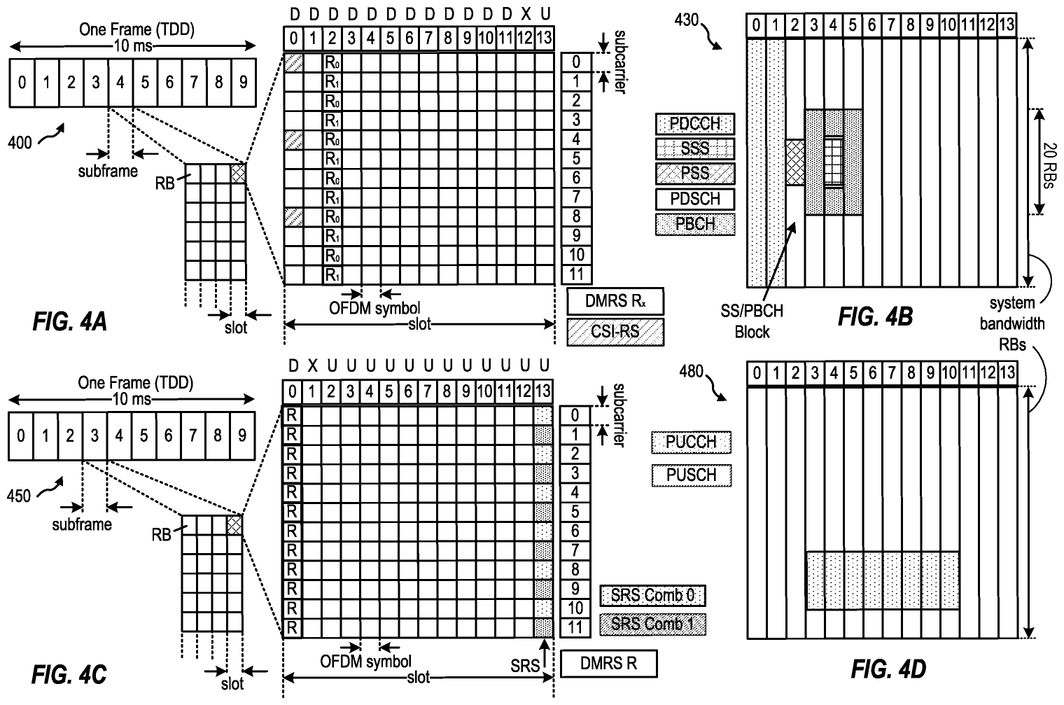

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (p) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2p slots/subframe. The subcarrier spacing and symbol length/duration are a function of the numerology. The subcarrier spacing may be equal to 2×15 kHz, where is the numerology 0 to 5. As such, the numerology p=0 has a subcarrier spacing of 15 kHz and the numerology p=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology p=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Multiple-Input Multiple-Output (MIMO) Systems

Multiple-input multiple-output (MIMO) is a multi-antenna technology that exploits multipath signal propagation so that information-carrying capacity of a wireless link can be multiplied by using multiple antennas at a transmitter node and a receiver node to send multiple simultaneous streams. At a multi-antenna transmitter node, a precoding technique (e.g., scaling the respective streams' amplitude and phase) is applied (e.g., based on known channel state information (CSI)). At a multi-antenna receiver node, the different spatial signatures of the respective streams (e.g., known CSI) can enable the separation of these streams from one another.

For example, a network entity (e.g., a gNodeB (gNB)) may include multiple antennas supporting MIMO technology. The use of MIMO technology enables the network entity to exploit spatial domain to support spatial multiplexing, beamforming, and transmit diversity. The spatial multiplexing may be used to transmit different streams of data simultaneously on a same frequency. The data steams may be transmitted to a single user equipment (UE) to increase a data rate or to multiple UEs to increase overall system capacity. This is achieved by spatially precoding each data stream (i.e., applying a scaling of an amplitude and a phase) and then transmitting each spatially precoded stream through multiple transmit antennas on a downlink. The spatially precoded data streams arrive at the UEs with different spatial signatures, which enables each of the UEs to recover the one or more data streams destined for that UE. On uplink, each UE transmits a spatially precoded data stream, which enables the network entity to identify the source of each spatially precoded data stream.

The performance of a MIMO system is related to a received signal-to-interference-and-noise ratio (SINR) and correlation properties of a multipath channel and antenna configuration. Using precoding techniques, the MIMO system can increase and/or equalize the received SINR across the multiple receive antennas. The transmitter node can utilize a plurality of complex weighting precoding matrices to precode the streams of a MIMO channel. The precoding matrices can be defined in a codebook where each precoding matrix can be identified by a precoding matrix index (PMI). When the codebook is known to both the transmitter node and the receiver node, the receiver node can inform the transmitter node to use a certain precoding matrix by sending the PMI of the desired precoding matrix to the transmitter node.

In new radio (NR) uplink, a UE can support up to 32 transmit (Tx) antennas, while the gNB can support up to 1024 receive (Rx) antennas. So, fine beamforming can be implemented on both the UE-Tx end and the BS-Rx end. With the significant increase in a number of antennas, an uplink MIMO gain of NR is much greater, including beamforming gain and multiplexing gain. However, since the achievable gain also depends on the design of the transmission technology, a closed loop-MIMO may be a preferred choice in the transmission scheme for uplink data channels. When an open-loop MIMO is used in uplink transmissions, benefits of increasing the number of antennas are limited. A semi-open-loop MIMO may be used in scenarios where accurate CSI cannot be obtained, such as UE movement, rotation, and partial channel reciprocity. In some cases, the open loop MIMO may allow the UE to report a rank indicator (RI) and channel quality indicator (CQI), while the closed loop MIMO may allow the UE to report RI, CQI and PMI.

### Overview of Hybrid Automatic Repeat Request (HARQ)

In some communication systems, there is an ongoing effort to reduce latency. For example, in 5G New Radio (NR) systems, there is an ongoing effort to reduce over-the-air latency. The NR system may include communications that are limited in time. As a result, some types of communications include feedback signaling.

One form of a feedback is a hybrid automatic repeat request (HARQ) feedback. The HARQ feedback may be provided by a receiver device (e.g., a user equipment (UE)) to a transmitter device (e.g., a gNodeB (gNB)), and may include transmission of several reporting signals to the transmitter device. Example reporting signals may include acknowledgement (ACK) signals representing an ACK state, and negative acknowledgement (NACK) signals representing a NACK state. An ACK signal may be transmitted as part of the HARQ feedback, in response to successful reception and decoding of a data transmission. A NACK signal may be transmitted as part of the HARQ feedback, in response to a reception of a data transmission but an unsuccessful decoding of the data transmission.

### Overview of HARQ Mechanisms

Hybrid automatic repeat request (HARQ) may enable reliable communication by leveraging forward error-correcting (FEC) coding at a physical layer and automatic retransmissions at a data link/medium access layer based on acknowledgment/negative acknowledgment (ACK/NACK) feedback on a reverse link. With the HARQ, a receiver device (e.g., a user equipment (UE), a gNodeB (gNodeB), etc.) may store previously received packets/data packets/transmissions from a transmitter device. The receiver device may use the stored packets for joint processing (e.g., combining) with a last received packet (e.g., a current packet) in order to enhance the decoding reliability.

Type I HARQ may add both error detection (ED) and FEC information to each message prior to transmission. When a coded data block/packet is received, the receiver device may first decode an error-correction code. If a channel quality is good enough, all transmission errors should be correctable, and the receiver device may obtain a correct data block. If the channel quality is bad and not all transmission errors can be corrected, the receiver device may detect this situation using the ED code. The received coded data block is then rejected and a re-transmission is requested by the receiver device.

In type II HARQ, a message originator may alternate between message bits along with ED parity bits and only FEC parity bits. When a first transmission is received error free, the FEC parity bits are never sent. Also, two consecutive transmissions can be combined for error correction if neither is error free.

In some cases, incorrectly received coded data blocks may be stored at the receiver device rather than discarded, and when a re-transmitted data block is received, two data blocks are combined. This may be called HARQ with soft combining. While it may be possible that two given data transmissions cannot be independently decoded without error, it may happen that the combination of the previously erroneously received data transmissions gives enough information to correctly decode.

Examples of HARQ mechanisms or soft combining methods may include chase combining HARQ (also referred to as chase-HARQ) and incremental redundancy (IR) HARQ (also referred to as IR-HARQ).

For the chase-HARQ, the transmitter device (e.g., an encoder) may repeat a same data packet at each retransmission. The receiver device (e.g., a decoder) performs decoding (e.g., attempts to decode) the data packet by combining all previously received data packets. For example, the decoder combines current received retransmitted data packets with an original (e.g., previously received and stored) erroneously transmitted data packet from a previous transmission, where the retransmissions are identical copies of the original transmission. This may involve all previously received data packets of the current combined data packet obtained from all previous transmissions.

For the IR-HARQ, at each retransmission, the transmitter device may send a data packet consisting of new parity bits. The receiver device stores all the previously received data packets. For example, additional redundant information is transmitted in each retransmission to increase a channel coding gain, where the retransmissions consist of new parity bits from a channel encoder. Different bits (e.g., new parity bits) may be transmitted by employing a different rate matching (puncturing) pattern, for example, which results in a smaller effective code rate of the stream.

In some cases, systematic bits and redundant bits may be interleaved. The systematic bits may be original input data bits, while parity bits (e.g., parity packets) may be used to find/correct errors that may occur during the data transmission. With the chase combining, a same redundancy version (RV) index may be sent. The IR-HARQ may be based on a RV sequence 0, 2, 3, 1 and the chase HARQ may be based on a RV sequence 0, 0, 0, 0 (e.g., no log likelihood ratio (LLR) combining for the ARQ).

In some cases, LLR may be expressed in a form of a noise vector divided by a received vector. In a wireless communication system using a multiple input multiple output (MIMO) based on a minimum mean square error (MMSE), the LLR may be used as a received vector due to implementation complexity.

In HARQ systems, data from previously received data packets may be stored in a HARQ buffer (e.g., which may be at the receiver device). Buffered data packets at the receiver device may be represented by quantizing LLRs of coded bits. The LLR may be a soft decision that indicates a likelihood of a coded bit being a 1 or 0. In certain systems, LLRs for an entire round trip time (RTT) duration may be buffered (e.g., stored in the HARQ buffer). The LLRs may be buffered, for example, in a physical layer (PHY) HARQ LLR buffer. In addition, for radio link control (RLC) ARQ, data may also be stored, for example, in a higher layer reordering buffer.

The IR-HARQ may have several benefits such as improved reliability (e.g., the incremental transmissions may allow the receiver device to gradually improve its estimate of the original data, even if some of the transmissions are lost or corrupted. This makes it possible to achieve high reliability even in the presence of a noisy or unreliable wireless channel), reduced latency (e.g., the IR HARQ may reduce an overall latency of a system, since it allows the receiver device to decode and use some of the data before all of the packets have been received), efficient use of resources (e.g., the IR HARQ may be more efficient since it only requires the retransmission of the data that was lost or corrupted, rather than requiring the entire packet to be resent), and compatibility with other schemes (e.g., the IR HARQ may be combined with other HARQ schemes, such as chase combining, to further improve the reliability and efficiency of the system). The IR-HARQ may also provide robustness against inaccurate rate control, bursty interference, etc.

In some cases, the benefits of the IR-HARQ may come at a cost. For example, a large memory may be needed at the receiver device to store HARQ LLRs for the soft combining for a large number of HARQ processes.

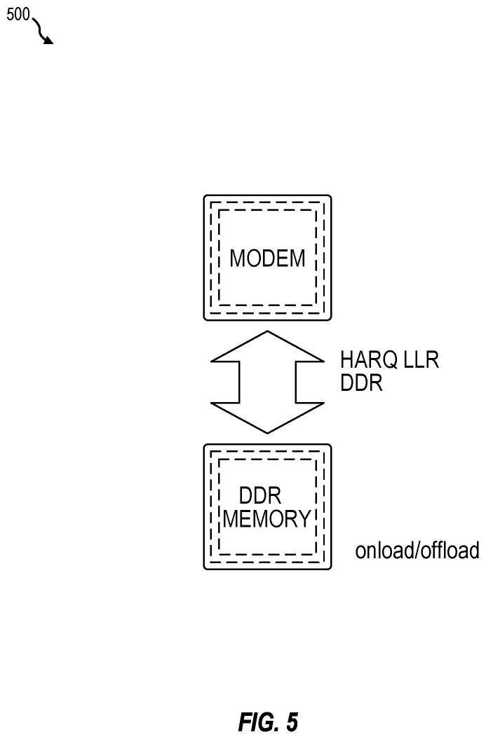

In some cases, with availability of new modem hardware architecture (e.g., as illustrated in a diagram 500 of FIG. 5) at the receiver device, the HARQ LLRs may be offloaded to a HARQ buffer (e.g., of the receiver device) and/or external memories (e.g., associated with the receiver device) through a double date rate (DDR). In such cases, a bandwidth of the DDR may limit how much information can be stored per LLR.

In some cases, to reduce a HARQ buffer size and DDR bandwidth requirement, the HARQ LLRs may be excessively compressed. For example, the HARQ LLRs may be compressed to be one bit per LLR (i.e., only store signs of the HARQ LLRs). This may be known as one bit companding (compressing). However, when companding/decompanding (decompressing) of the HARQ LLRs may be performed in a natural way or using currently available methods, there may be a large performance loss caused due to the excessive compression of the HARQ LLRs.

Accordingly, new companding/decompanding techniques, which may use one bit per LLR but also achieve a performance that is very close to a floating point are desirable.

In some aspects, for a higher order quadrature amplitude modulation (QAM), LLRs for bits such as most significant bit (MSB) and least significant bit (LSB) are highly correlated. The LSB may be a bit position in a binary integer representing the binary is place of an integer. The MSB may represent a highest-order place of the binary integer. The LSB may be referred to as a low-order bit or right-most bit. The MSB may be referred to as a high-order bit or left-most bit.

In 5G new radio (NR) (and other systems), a 256 QAM modulation may map a set of eight bits (e.g., b (8i), b (8i+1), b (8i+2), b (8i+3), b (8i+4), b (8i+5), b (8i+6), b (8i+7)) into complex-valued modulation symbols d (i) according to equation 1 shown below.

$$d ( i ) = \frac{1}{\sqrt{170}} \{ ( 1 - 2 b ( 8 i ) ) [ 8 - ( 1 - 2 b ( 8 i + 2 ) ) [ 4 - ( 1 - 2 b ( 8 i + 4 ) ) [ 2 - ( 1 - 2 b ( 8 i + 6 ) ) ] ] ] + j ( 1 - 2 b ( 8 i + 1 ) ) [ 8 - ( 1 - 2 b ( 8 i + 3 ) ) [ 4 - ( 1 - 2 b ( 8 i + 5 ) ) [ 2 - ( 1 - 2 b ( 8 i + 7 ) ) ] ] ] \} \qquad Equation 1$$

Per equation 1, bits b (8i) and b (8i+1) may map to a sign of in-phase and quadrature (I and Q) component of a modulation symbol/QAM symbol. These are MSB bits (e.g., of the modulation). Bits b (8i+2) and b (8i+3) may be second MSB bits of the I and Q component, respectively. Bits b (8i+4) and b (8i+5) may be second LSB bits (or third MSB bits) of the I and Q component, respectively. Lastly, bits b (8i+6) and b (8i+7) may be LSB bits of the I and Q component, respectively.

Furthermore, for simplicity of explanation, the present disclosure may focus on per I/Q modulation symbol (i.e., real part and imaginary part of a QAM symbol). In such cases, four bits (e.g., b (8i), b (8i+2), b (8i+4), b (8i+6)) may be mapped into the real part of the QAM symbol. And other four bits (e.g., b (8i+1), b (8i+3), b (8i+5), b (8i+7)) may be mapped to the imaginary part of the QAM symbol.

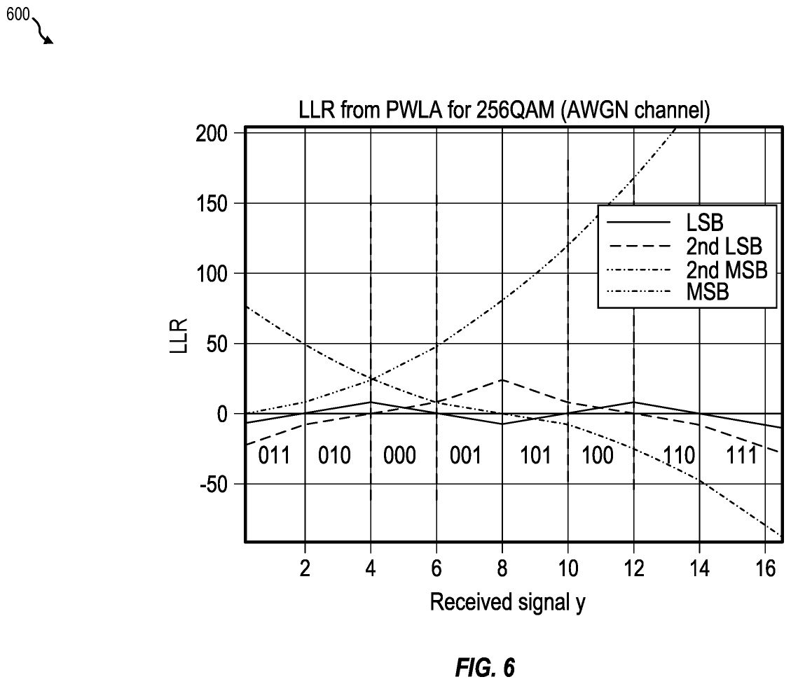

In some aspects, sign(s) of the LSB(s) may include some amount of information for the MSB(s). A sign of a real number may be its property of being either positive, negative, or 0. For example, for a max-log-map demodulation, all LLRs may be piece-wise linear functions of a (noise-added) received signal y (e.g., as illustrated in LLR distribution of the received signal y depicted a diagram 600 of FIG. 6). Hard decisions (HDD) on the LSBs may reveal a region in which the received signal may lie. That is, three bits may be provided for free for the LLR of the MSB (e.g., for 256QAM) from HDD bits of the LSB. This may enable the receiver device to reconstruct the LLRs of the MSB(s) conditioned on the HDD of the LSBs.

Accordingly, the new techniques proposed herein may enable the receiver device to reconstruct the LLRs (e.g., the companded LLRs) based on a symbol-HDD (i.e., hard decision symbol per I/Q. The “in-phase” and “quadrature” may refer to two sinusoids that have a same frequency and are 90° out of phase. The symbol-HDD may be obtained from the signs of the LLRs that are associated with a same symbol (e.g., a modulation symbol). In some cases, at a base band, the I and Q part of a constellation may be considered as the real part and the imaginary part of a complex QAM modulation.

### Aspects Related to Symbol-Level Based LLR Companding and Decompanding

Aspects of the present disclosure provide apparatuses, methods, processing systems, and computer-readable mediums for symbol-based processing (e.g., companding and/or decompanding) of log likelihood ratios (LLRs) of packets.

Techniques proposed herein may enable a receiver device to jointly reconstruct multiple LLRs (e.g., companded/compressed LLRs) that are associated with a same modulation symbol. For example, for the companding, the receiver device may only store signs of the LLRs (e.g., which results in one bit per LLR). For the decompanding, the receiver device may reconstruct the multiple companded LLRs jointly that may be associated with the same modulation symbol based on the signs of these companded LLRs.

Particular aspects of the subject matter described in this disclosure can be implemented for chase combining HARQ and incremental redundancy (IR) HARQ (IR-HARQ) to realize one or more of the following potential advantages. In some examples, the described techniques may improve overall performance of companding/decompanding operations (i.e., reduced loss of information during the companding/decompanding).

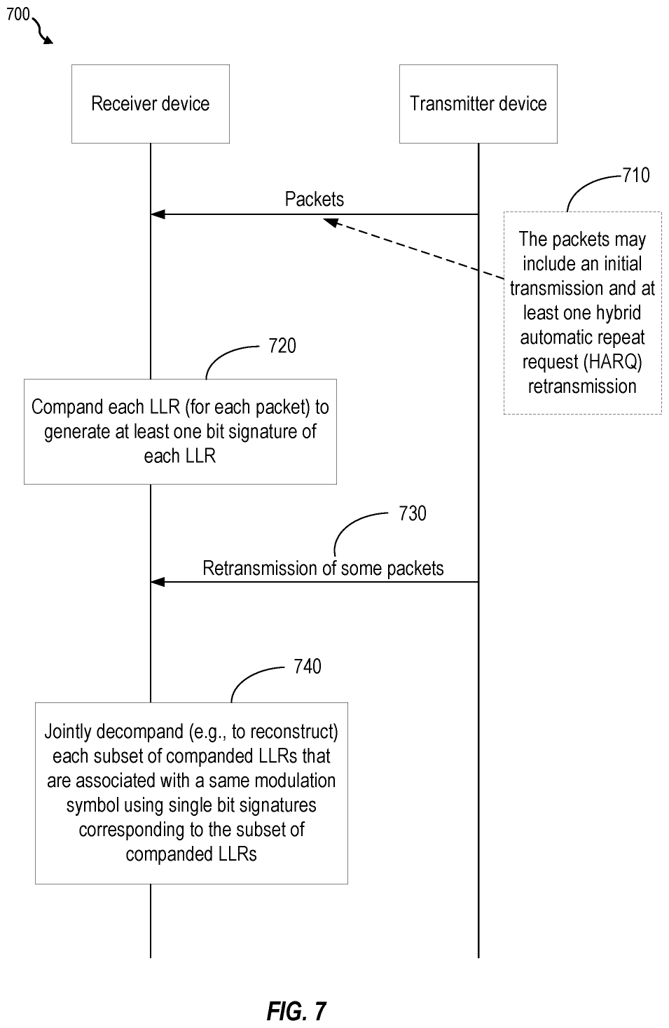

The techniques proposed herein for managing the companding and decompanding of the LLRs of the packets may be understood with reference to FIGS. 7-19.

FIG. 7 depicts a call flow diagram 700 illustrating example communication among a receiver device and a transmitter device for managing companding and decompanding of one or more LLRs of one or more packets.

In one aspect, the receiver device shown in FIG. 7 may be an example of the UE 104 depicted and described with respect to FIG. 1 and FIG. 3. In another aspect, the receiver device shown in FIG. 7 may be an example of the BS 102 depicted and described with respect to FIG. 1 and FIG. 3, or the disaggregated BS depicted and described with respect to FIG. 2.

In one aspect, the transmitter device shown in FIG. 7 may be an example of the UE 104 depicted and described with respect to FIG. 1 and FIG. 3. In another aspect, the transmitter device shown in FIG. 7 may be an example of the BS 102 depicted and described with respect to FIG. 1 and FIG. 3, or the disaggregated BS depicted and described with respect to FIG. 2.

As indicated at 710, the transmitter device sends (or transmits) the one or more packets to the receiver device. The one or more packets may include an initial transmission and at least one HARQ retransmission. For example, the packets may include the initial transmission and multiple HARQ retransmissions.

As indicated at 720, the receiver device compands (e.g., quantize, compress) each LLR (e.g., one or more LLRs may be associated with the one or more packets and are generated at the receiver device) to generate at least one bit sign of each LLR. The receiver device may store the at least one bit sign corresponding to the each LLR. For example, for companding operation (i.e., compression), the receiver device may store the signs of the LLRs (e.g., which results in one bit per LLR) in one or more buffers (e.g., HARQ buffers) or memories of the receiver device.

In certain aspects, different companded LLRs may be associated with different modulation symbols. In one example, a first set of companded LLRs may be associated with a first modulation symbol. In another example, a second set of companded LLRs may be associated with a second modulation symbol. The first set of companded LLRs are different from the second set of companded LLRs.

In certain aspects, the receiver device may compand separately for each bit, regardless of a most significant bit (MSB)/least significant bit (LSB). For example, a positive LLR may be mapped to 0 and a negative LLR may be mapped to 1, regardless of their magnitude or modulation level.

The MSB may be a bit in a multiple-bit binary number with a largest value. This is the bit farthest to the left, or the bit transmitted first in a sequence. For example, in a binary number 1000, the MSB is 1, and in a binary number 0111, the MSB is 0. When the MSB in a sequence is farthest to the left (or first), the LSB may be the one farthest to the right (or last).

As indicated at 730, the transmitter device may retransmit all of the one or more packets to the receiver device. In some cases, the transmitter device may retransmit at least one of the one or more packets to the receiver device. In some cases, the transmitter device may retransmit some portions/parts of the one or more packets to the receiver device. The receipt of the retransmitted packets at the receiver device may trigger the receiver device to on load the companded LLRs from a memory of the receiver device to a modem of the receiver device. The receiver device may then decompand the companded LLRs, and combine the decompanded LLRs with new signals/packets received in the retransmission.

For example, as indicated at 740, the receiver device jointly decompands (e.g., dequantize, decompress, reconstruct) each subset of companded LLRs associated with a same modulation symbol using single bit signs corresponding to the subset of companded LLRs. For example, the receiver device may jointly reconstruct the subset of companded LLRs associated with the same modulation symbol, based on the single bit signs corresponding to the subset of companded LLRs (i.e., for a decompanding operation, the LLRs that are associated with the same modulation symbol may be jointly reconstructed based on the signs of these LLRs).

In certain aspects, different decompanding schemes may be associated with different modulation orders. The decompanding schemes may include a first decompanding scheme and a second decompanding scheme. The modulation orders may include a first modulation order and a second modulation order. In one example, the first decompanding scheme may be associated with the first modulation order. In another example, the second decompanding scheme may be associated with the second modulation order.

In certain aspects, the receiver device may jointly decompand the first set of companded LLRs associated with the first modulation order, using the first decompanding scheme, based on single bit signs corresponding to the first set of companded LLRs. In the same way, the receiver device may jointly decompand the second set of companded LLRs associated with the second modulation order, using the second decompanding scheme, based on single bit signs corresponding to the second set of companded LLRs.

In certain aspects, a decompanding scheme may at least depend on a modulation order, and therefore, a different modulation order may need a different decompanding scheme. For example, when there may be separate decompanding, then bit 0 may map to A, bit 1 may map to −1. The same mapping applies to all bits, regardless of a modulation level. The joint companding of two bits (e.g., bits 00, 01, 10, 11) may mean that these bits may be mapped to different amplitudes for each bit. For example, bits 00 may map to amplitudes+1, +3; bits 01 may map to amplitudes+2, −2; bits 10 may map to amplitudes −1, +3; and bits 11 may map to amplitudes −2, −2. As shown, the amplitude of the decompanded LLR of the MSB may be different depending on a value of the LSB bit. Similar process may be applicable for the LSB decompanding.

In certain aspects, each modulation symbol may be mapped to one or more bits including MSB and LSB, in accordance with a modulation scheme.

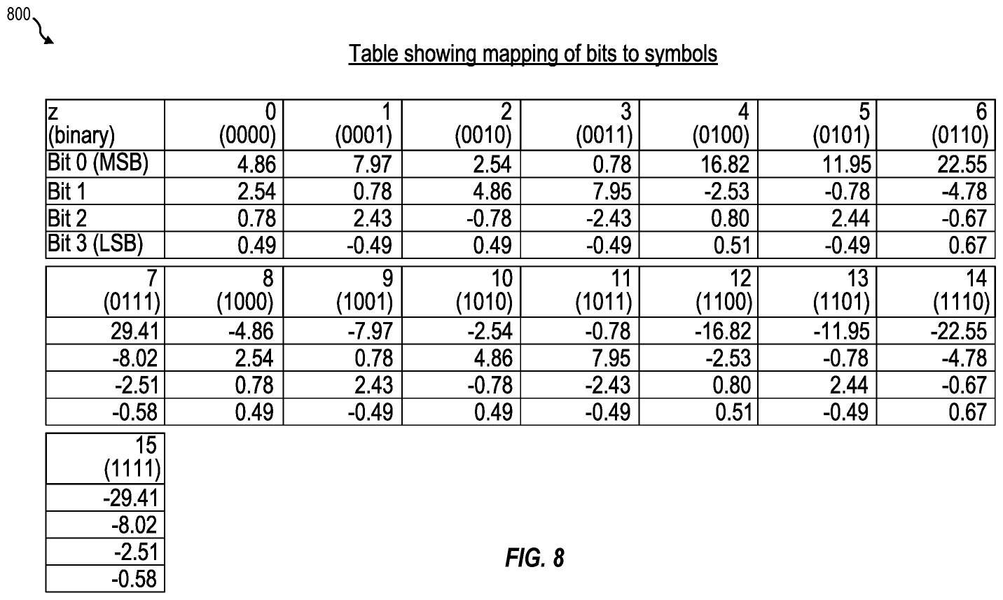

FIG. 8 depicts a diagram 800 showing a table indicating mapping of bits to symbols (e.g., modulation symbols). The bits may include a bit 0, a bit 1, a bit 2, and a bit 3. The bit 0 may be MSB. The bit 3 may be LSB. As depicted, every four bits may be mapped to one symbol per in-phase and quadrature (I/Q). The “in-phase” and “quadrature” may refer to two sinusoids that have a same frequency and are 90° out of phase. For companding operation, the receiver device may store signs of four LLRs (e.g., one bit per LLR). For decompanding operation, the receiver device may recover the four LLR values associated with the same I/Q symbol via the four signs. Example values for the recovered LLR magnitudes are showing in a table of FIG. 8.

In certain aspects, a real additive white gaussian noise (AWGN) channel y may be equal to x+n, where x∈Sₘ represents pulse-amplitude modulation (PAM) symbols with an order m (i.e., |Sₘ|=₂m). “n” represents AWGN noise. “x+n” represents a received signal, in which a transmitted signal x is corrupted by the AWGN noise n. A demodulator may perform symbol detection to output a most likely symbol \hat{x}∈Sₘ. This may convert the AWGN channel into a discrete memoryless channel (DMC) with a transition probability P_{x,\hat{x}} as shown below in equation 2.

$${P}_{x , \hat{x}} = \{ \begin{matrix}\begin{matrix}Q ( {d}_{x , \hat{x}} - \frac{{d}_{min}}{2} ) - Q ( {d}_{x , \hat{x}} + \frac{{d}_{min}}{2} ) , \hat{x} \neq x , and \hat{x} is inner \\ constellation\end{matrix} \\ Q ( {d}_{x , \hat{x}} - \frac{{d}_{min}}{2} ) , \hat{x} \neq x , and \hat{x} is the outer constellation \\ 1 - {\sum }_{{x}^{′} \neq x} {P}_{x , {x}^{′}} , \hat{x} = x\end{matrix} \qquad Equation 2$$

where d and dₘᵢₙ represent distances between symbols (e.g., which may be scaled by a transmit power, and a fading channel coefficient).

In some cases, the outer constellation may indicate constellation points on a boundary of a constellation set. For example, for 256 QAM, each I/Q dimension may take one of 16 possible values (e.g., −15, −13, −11, . . . , 1, 3, . . . , 13, 15). Here, values −15 and 15 may denote the outer constellation, and others values (such as −13, −11, . . . , 11, 13) may be inner constellations.

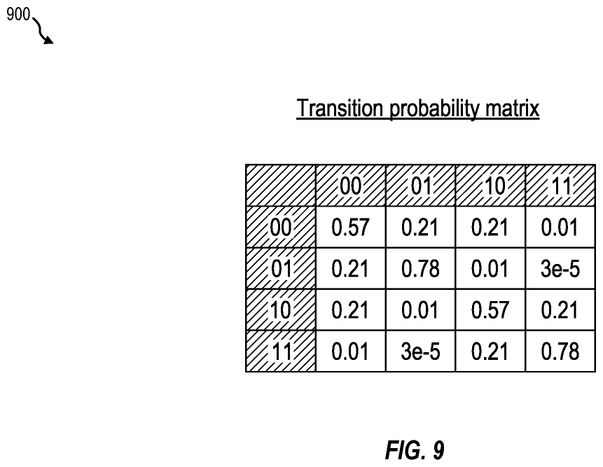

In certain aspects, different transition probability matrices may be associated with different modulation schemes. The receiver device may compute the LLRs for the MSB and the LSB for the modulation symbol based on a transition probability matrix (e.g., as depicted in a diagram 900 of FIG. 9) associated with the modulation scheme. For example, the LLRs for the MSB and the LSB may be generated from the transition probability matrix and are conditioned on a symbol hard-decision (HDD) \hat{x} as follows:

$$LLR ( {b}_{i} \vert \hat{x} ) = log \frac{P r ( \hat{x} \vert {b}_{i} = 0 )}{P r ( \hat{x} \vert {b}_{i} = 1 )} = log \frac{{\sum }_{x ∈ {S}_{m} : {b}_{i} = 0} {P}_{x , \hat{x}}}{{\sum }_{x ∈ {S}_{m} : {b}_{i} = 1} {P}_{x , \hat{x}}}$$

where Pᵣ denotes a probability, bᵢ denotes a bit whose LLR has to be reconstructed.

In some cases, an optimal LLR reconstruction may depend on a signal to noise ratio (SNR) of a channel.

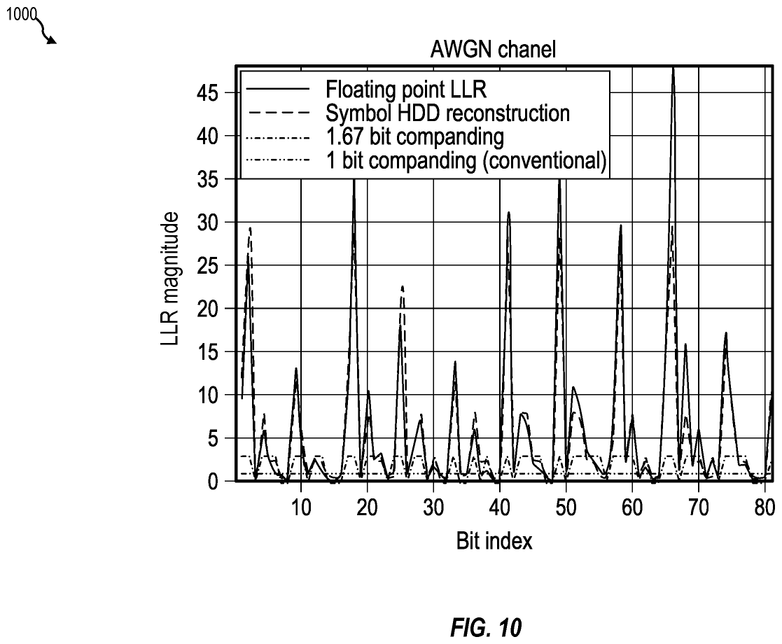

FIG. 10 depicts a diagram 1000 showing a graph illustrating LLR distribution of different bits. For example, the graph illustrates a distribution of the LLR computed with a noise-added received signal at a receiver device. As depicted, a symbol HDD LLR reconstruction tracks an actual LLR quite well. For example, there are 64 LLR level values for the symbol HDD vs the 4 LLR level values for a bit HDD.

In certain aspects, the receiver device may map each bit sign to one respective LLR of the LLRs using one or more lookup tables (LUTs).

In certain aspects, the receiver device may decompand the each subset of companded LLRs that are associated with the same modulation symbol, using the one or more LUTs. For example, the symbol HDD decompanding may be implemented via LLR LUTs.

In certain aspects, the receiver device may store the one or more LUTs per modulation order in the one or more buffers of the receiver device. For example, the LLR LUTs may be stored per modulation order in the one or more buffers.

In certain aspects, the receiver device may store the one or more LUTs per modulation and coding scheme (MCS) in the one or more buffers of the receiver device. For example, the LLR LUTs may be stored per MCS in the one or more buffers.

In certain aspects, the receiver device may store the one or more LUTs per SNR range and per modulation order in the one or more buffers of the receiver device. For example, the LLR LUTs may be stored per SNR range/bin and modulation order in the one or more buffers.

In certain aspects, a size of the LLR LUT may be m*2\hat{ }(m−1), where m represents a modulation order per I/Q (e.g., m=4, 3, 2 for 256 quadrature amplitude modulation (QANM), 64 QAM, 16 QAM respectively).

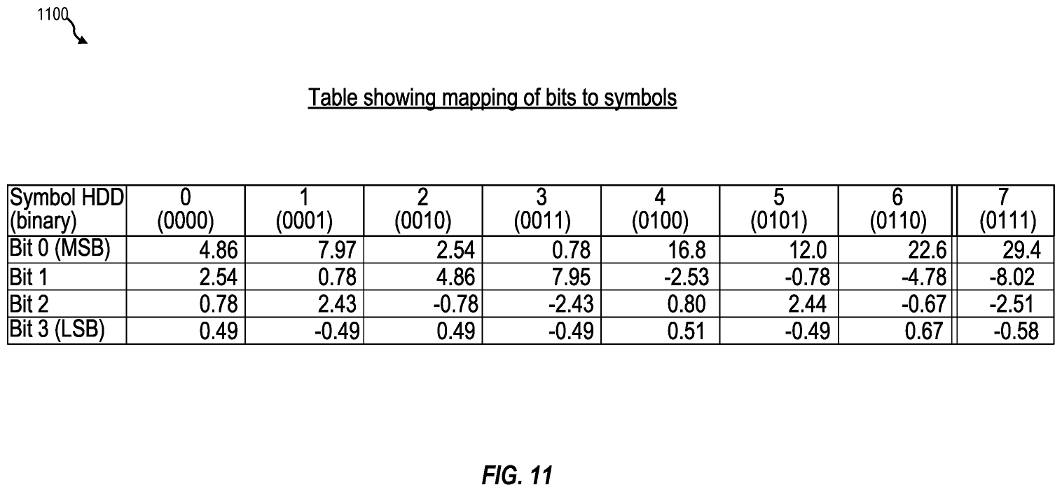

In certain aspects, due to symmetry (i.e., the LLR magnitude for MSB of the 0xxx and 1xxx may be the same, and may only differ by the signs), a size of the LLR LUT may be reduced by half. For example, the signs of the reconstructed LLRs may match the actual stored signs. That is, it may be suffice to only store the magnitudes of the LLRs in the LLR LUT. Furthermore, for the LSB, it may be sufficient to store only one LLR magnitude (e.g., as can be seen in a table 1100 of FIG. 11).

In certain aspects, the receiver device may store the modulation order for each transport block (TB), which may be used by the receiver device to determine which LLR LUT to use during companding/decompanding operation.

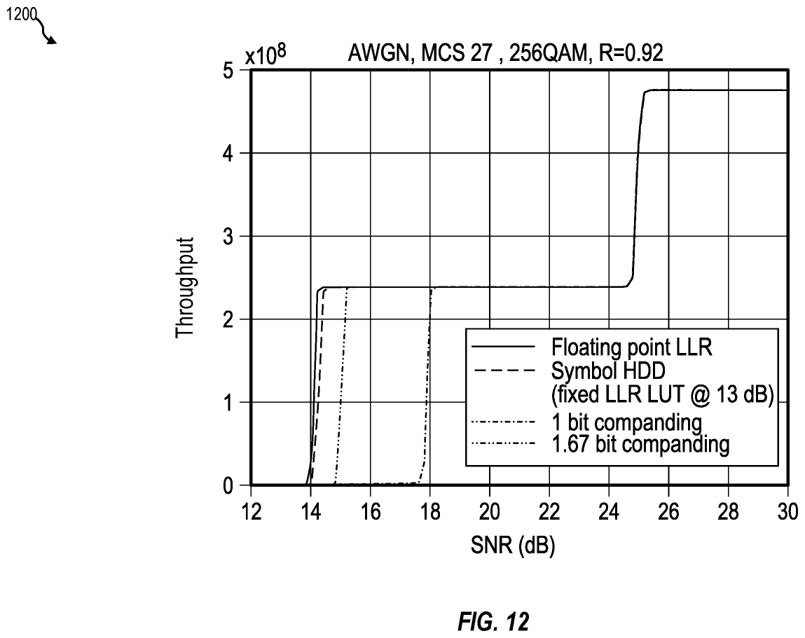

FIG. 12 depicts a diagram 1200 showing example graph illustrating throughput distribution for different values of SNRs for a first set of parameters. The first set of parameters may include at least use of AWGN channel, a MCS value of 27, 256 QAM, and a value of R being equal to 0.92. Here, R indicates a coding rate.

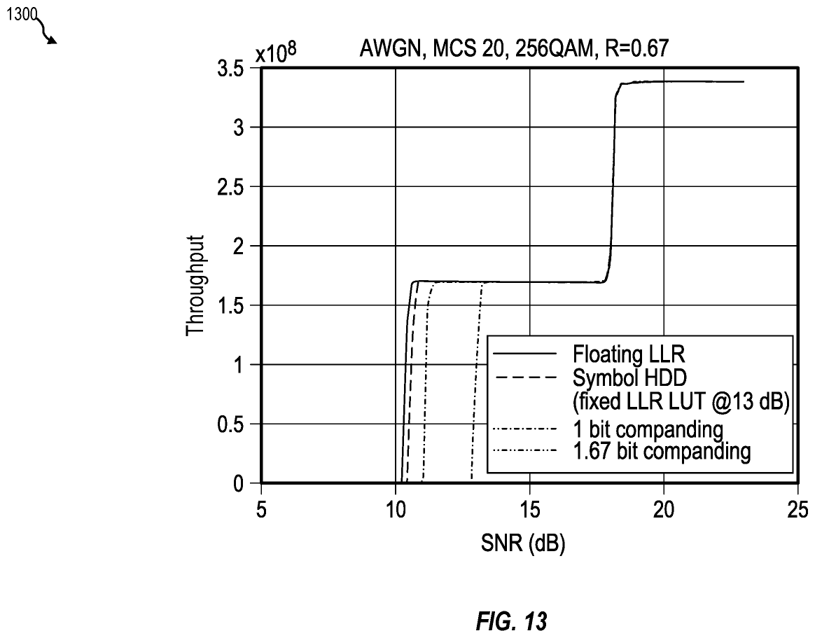

FIG. 13 depicts a diagram 1300 showing example graph illustrating throughput distribution for different values of SNRs for a second set of parameters. The second set of parameters may include at least use of AWGN channel, a MCS value of 20, 256 QAM, and a value of R being equal to 0.67.

As depicted in FIG. 12 and FIG. 13, a symbol-HDD based multi-level decompanding (e.g., reconstruction of companded LLRs) may outperform 1.67 bit companding method with 40% (e.g., 1.67 bit companding method >1 bit companding method per LLR) double date rate (DDR) memory bandwidth and soft-buffer reduction.

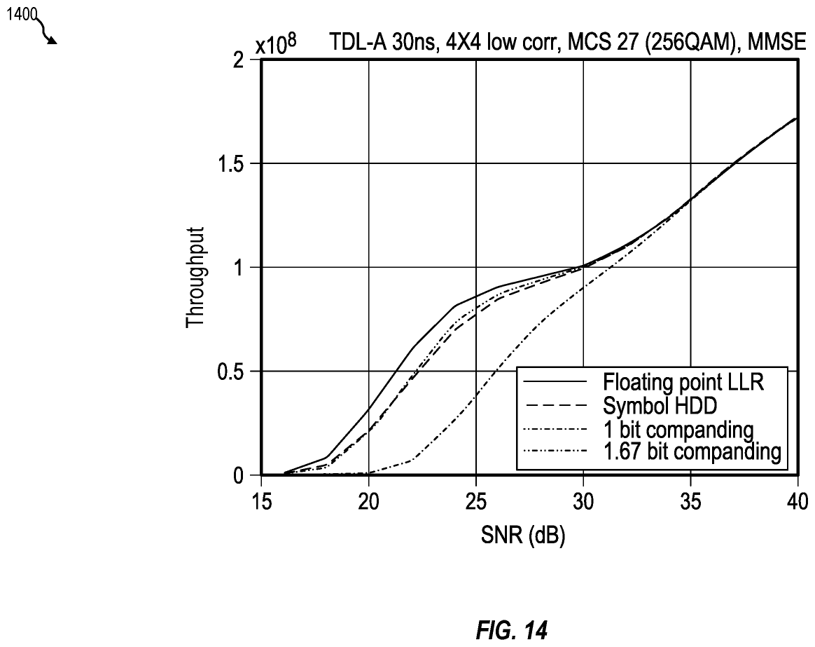

FIG. 14 depicts a diagram 1400 showing example graph illustrating throughput distribution for different values of SNRs for a third set of parameters. The third set of parameters may include at least use of a tapped delay line (TDL) model A with a delay spread of 30 nano second (ns), a 4x4 multiple input multiple output (MIMO) channel, MCS value of 27, 256 QAM, and use of a minimum mean squared error (MMSE) equalizer.

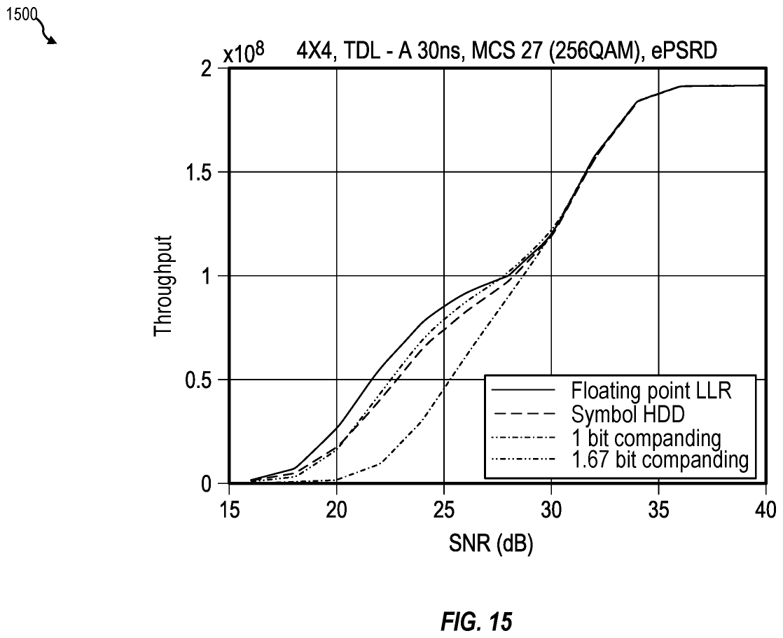

FIG. 15 depicts a diagram 1500 showing example graph illustrating throughput distribution for different values of SNRs for a fourth set of parameters. The fourth set of parameters may include at least use of a TDL model A with a delay spread of 30 ns, a 4×4 MIMO channel, MCS value of 27, 256 QAM, and a non-linear MIMO demodulator.

As depicted in FIG. 14 and FIG. 15, a symbol HDD based multi-level decompanding (e.g., reconstruction of companded LLRs) may provide comparable performance to 1.67 bit companding method.

In certain aspects, for MIMO fading channels, SNR values across different tones, resource blocks (RBs), and/or layers may be different (e.g., due to frequency selectivity). So, in some cases, it may not be optimal to reconstruct the LLRs using a same LUT.

In certain aspects, for the MIMO fading channels and a non-linear demodulator (e.g., a machine learning demodulator), the LLRs may depend on a received signal and interferences in other layers, which may make correlations between LSBs and MSBs slightly different from those observed in the AWGN channel.

In certain aspects, the receiver device may receive the one or more packets from the transmitter device on different resources.

In one aspect, the receiver device may compute an actual SNR for per layer associated with the different resources. In another aspect, the receiver device may compute the actual SNR for per code block (CB) associated with the different resources. In another aspect, the receiver device may compute the actual SNR for per resource block group (RBG) associated with the different resources. For example, an effective SNR may be computed for one or more of per layer, per CB, per RBG, etc. So, the receiver device may be able to use different LLR LUTs to reconstruct the LLRs, which may belong to different layers, CBs, RBG, etc. This may provide a finner granularity to match the reconstructed LLRs with the actual LLRs. This technique may be useful for MMSE based demodulation (e.g., since the LLRs effectively are AWGN LLRs given the effective SNRs).

In certain aspects, the receiver device may store the actual SNRs corresponding to the different resources in the one or more buffers of the receiver device.

In certain aspects, the LLRs may belong to different layers, CBs and/or RBGs associated with the different resources. The different layers, CBs and/or RBGs may be associated with different LUTs. The different LUTs may store mapping of the LLRs to at least one bit signs of the LLRs.

In certain aspects, the receiver device may decompand the each subset of companded LLRs associated with a different layer, CB or RBG using a corresponding LUT. For example, in addition to the signs of the LLRs and the modulation order, the receiver device may also store the effective SNRs for the different resources and use the effective SNR to determine a corresponding LLR LUT to use for decompanding operation.

In certain aspects, the receiver device may compute an average LLR value for MSB and/or LSB of the companded LLRs conditioned on each symbol HDD, and then reconstruct the companded LLRs using the computed average LLR value. For example, the receiver device may first compute an average LLR magnitude value that may be conditioned on the symbol HDD (i.e., the joint signs of the LLRs corresponding to the modulation symbol), and then use the computed average LLR value as the decompanding value for a given symbol HDD.

In some cases, an average LLR value may be computed across the LLRs corresponding to the different modulation symbols, but an average LLR for one bit level (e.g., the MSB) may be computed conditional on the companded values of the LLRs (i.e., averaged over the LLRs of a same bit level corresponding to all modulation symbols that have the same symbol HDD). For example, there may be 1000 subsets of LLRs and each subset may include two bits (e.g., the MSB and the LSB). There may be four different possibilities of MSB/LSB combination, such as, 00, 01, 10, 11. The receiver device may determine subsets among the 1000 subsets of LLRs, which may have a corresponding MSB/LSB LLR being companded to 00. The determined subsets may be represented by A00. The receiver device may compute an average LLR of the MSBs for all MSB LLRs within the A00, and an average LLR of the LSBs for all LSB LLRs within the A00. This may provide the decompanded LLR values of the MSB and the LSB, when the companded values are 00. Similarly, the receiver device may also compute the decompanded LLR values for other MSB/LSB combinations, such as, 01, 10, 11.

In some cases, a TB may include m*N LLRs, where N represents a number of real modulation symbols (e.g., N/2 complex symbols). The LLRs may be first grouped into groups of size m (i.e., m LLRs corresponding to the same modulation symbol form an LLR group). The LLR groups may then be partitioned into 2^{m} set according to the symbol HDD.

For example, in a first set, there may be N₁ groups of LLRs which may correspond to a symbol HDD 1, a second set may include N₂ groups of LLRs which may correspond to a symbol HDD 2, etc., where N₁+N₂+ . . . +N₂_{ₘ}=N. The receiver device may compute m average LLR magnitude values for bits corresponding to a same set and a same bit level (i.e., LSB vs MSB). The average LLR magnitude values may be computed using a maximum mutual information (MMI) principle using the below equation 3.

$${L}_{a v g} ( {\{ {L}_{i}^{( j )} \}}_{i = 0}^{{N}_{k} - 1} \vert symbol HDD ) = log \frac{\frac{1}{{N}_{k}} {\sum }_{i = 0}^{{N}_{k} - 1} {( 1 + exp ( - \vert {L}_{i}^{( j )} \vert ) )}^{- 1}}{\frac{1}{{N}_{k}} {\sum }_{i = 0}^{{N}_{k} - 1} {( 1 + exp ( \vert {L}_{i}^{( j )} \vert ) )}^{- 1}} \qquad Equation 3$$

In the equation 3, L_{avg} represents an average LLR value to be computed. Nₖ (as explained above) denotes a number of groups of LLRs that are associated with a symbol HDD value equal to k. Lᵢ denotes “uncompressed” LLR values of ith group in Nₖ groups. Superscript (j) refers to jth position in a modulation symbol. For example, when a group contains 2 LLRs, then j=0, 1 means 1st and 2nd element in the group, which may correspond to MSB LLR and LSB LLR of the modulation symbol, respectively.

Based on the above-noted techniques, the receiver device may determine empirical average LLR magnitude values for each symbol HDD and then use these values to reconstruct the LLRs.

In some cases, the receiver device may store the computed average LLR magnitude in the memory. The receiver device may later use the stored computed average LLR magnitude for LLR decompanding/reconstruction operations.

In some cases, for all LLR groups with the symbol HDD equal to k, L_{avg} may be used as reconstructed LLR values. Also, for each symbol HDD k, there may be m different LLR values in L_{avg}.

In certain aspects, to improve performance, the receiver device may compand using more than one bit per LLR (e.g., for LSB bits) and then use the above-noted conditional/joint decompanding techniques to decompand the companded LLRs.

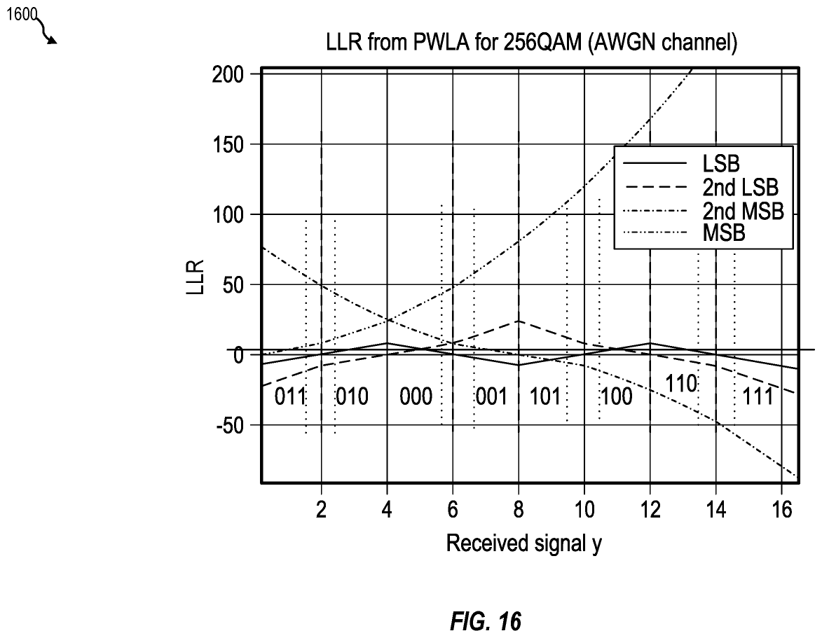

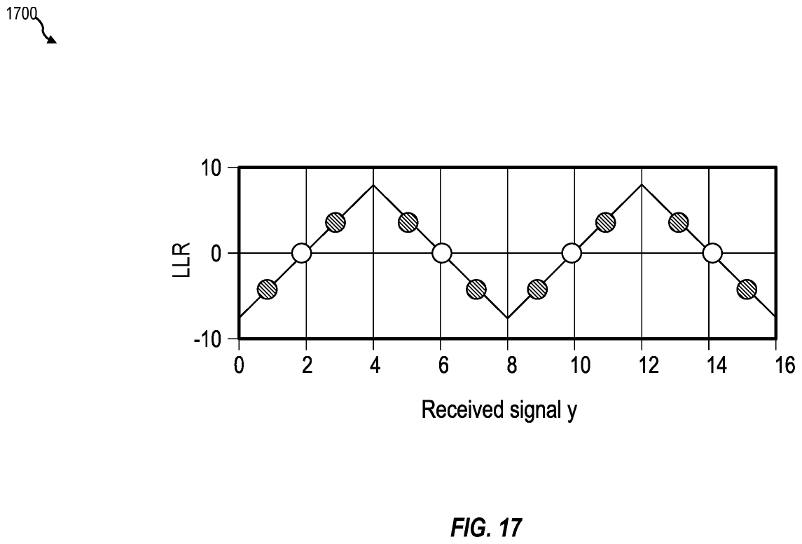

One example of using one bit for the MSB, and three states (−1, +1, erasure) for the LSB is shown in FIG. 16/FIG. 17. FIG. 16 and FIG. 17 depict diagrams 1600, 1700 showing graphs illustrating LLR distribution of a signal y received by a receiver device.

In some cases, the receiver device may quantize a modulation symbol to 3*2*2*2=24 states (or 12 states on each positive/negative quadrant as shown in FIG. 16/FIG. 17). The receiver device may jointly reconstruct 4 LLR values based on joint companding values of 4 LLRs.

In some cases, adding an erasure state for a LSB LLR may be equivalent to add four additional points (from 8 to 12) for a symbol HDD for the I/Q part of a 256QAM modulation scheme.

In certain aspects, the initial transmission may be associated with a first set of modulation symbols, and each HARQ retransmission may be associated with a second set of modulation symbols. The second set of modulation symbols may be different from the first set of modulation symbols. In other aspects, the initial transmission may be associated with a first set of modulation symbols, and each HARQ retransmission may be associated with the same first set of modulation symbols. For example, for each HARQ retransmission, a transmission may only retransmit either new modulation symbols (e.g., with totally new bits) or the same modulation symbols that were used in previous transmissions. That is, retransmissions may happen in a unit of (real) modulation symbols, instead of bits.

In certain aspects, a symbol-based (i.e., modulation symbol based) circular buffer for HARQ may be adopted. For example, when a set of bits are modulated to a same symbol in one HARQ transmission, the HARQ transmission may have to be retransmitted with the same modulation symbol for retransmission. This way, during HARQ combining, corresponding LLRs may still correspond to the same modulation symbol after soft HARQ combining, and hence can be decompanded with a same symbol HDD scheme.

In certain aspects, the techniques described herein may be used when a HARQ retransmission may have a same modulation order as all initial transmissions. When the modulation order of any HARQ retransmission is different from a previous transmission of a same TB, then transmit/receive operations may use a bit-level HARQ buffer.

### Example Receiver Device Operations

FIG. 18 shows an example of a method 1800 of wireless communications at a receiver device, such as user equipment (UE) (e.g., UE 104 of FIGS. 1 and 3) or a network entity (e.g., a BS 102 of FIGS. 1 and 3, or a disaggregated base station as discussed with respect to FIG. 2).

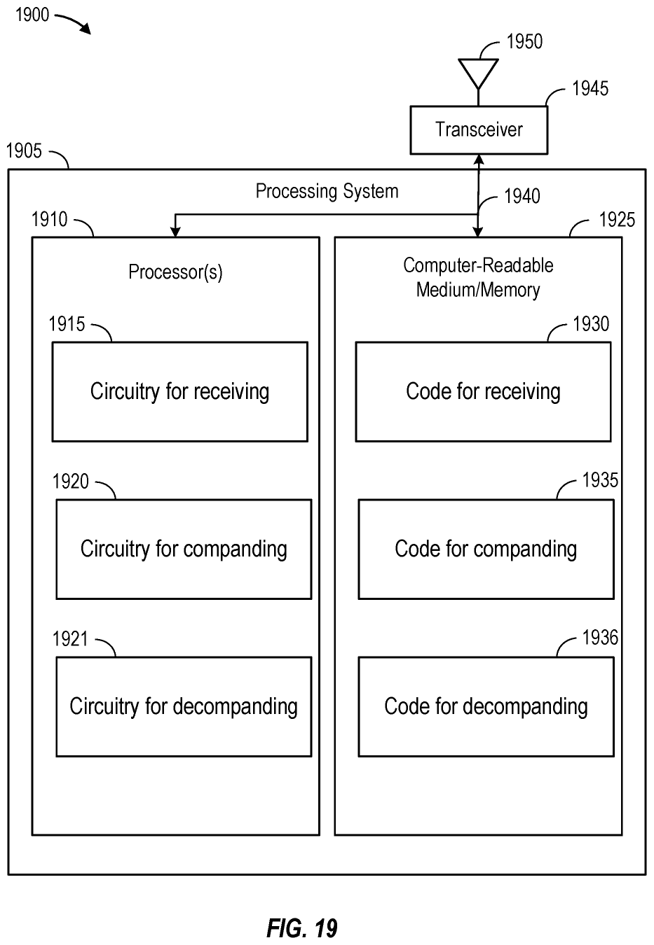

Method 1800 begins at step 1810 with receiving packets including an initial transmission and at least one hybrid automatic repeat request (HARQ) retransmission. In some cases, the operations of this step refer to, or may be performed by, circuitry for receiving and/or code for receiving as described with reference to FIG. 19.

Method 1800 begins at step 1820 with obtaining log likelihood ratios (LLRs) for the packets. In some cases, the operations of this step refer to, or may be performed by, circuitry for receiving and/or code for receiving as described with reference to FIG. 19.

Method 1800 begins at step 1830 with companding each LLR to generate at least one bit sign of each LLR. In some cases, the operations of this step refer to, or may be performed by, circuitry for companding and/or code for companding as described with reference to FIG. 19.

Method 1800 begins at step 1840 with jointly decompanding each subset of companded LLRs that are associated with a same modulation symbol using single bit signs corresponding to the subset of companded LLRs. In some cases, the operations of this step refer to, or may be performed by, circuitry for decompanding and/or code for decompanding as described with reference to FIG. 19.

In some aspects, the jointly decompanding includes reconstructing the subset of companded LLRs associated with the same modulation symbol jointly based on the single bit signs corresponding to the subset of companded LLRs.

In some aspects, different decompanding schemes are associated with different modulation orders; the different decompanding schemes comprise at least a first decompanding scheme and a second decompanding scheme; and the different modulation orders comprise at least a first modulation order and a second modulation order.

In some aspects, the method 1800 further includes jointly decompanding, using the first decompanding scheme, a first set of companded LLRs associated with the first modulation order, based on single bit signs corresponding to the first set of companded LLRs.

In some aspects, the method 1800 further includes jointly decompanding, using the second decompanding scheme, a second set of companded LLRs associated with the second modulation order, based on single bit signs corresponding to the second set of companded LLRs.

In some aspects, the method 1800 further includes storing the at least one bit sign corresponding to the each LLR in one or more buffers of the receiver device.

In some aspects, each modulation symbol is mapped to one or more bits comprising at least one of a most significant bit (MSB) or a least significant bit (LSB) in accordance with a modulation scheme; computing the LLRs for the MSB and the LSB for the modulation symbol based on a transition probability matrix associated with the modulation scheme; and different transition probability matrices are associated with different modulation schemes.

In some aspects, the method 1800 further includes mapping each bit sign to one respective LLR of the LLRs using one or more lookup tables (LUTs).

In some aspects, the decompanding includes decompanding the each subset of companded LLRs that are associated with the same modulation symbol using the one or more LUTs.

In some aspects, the method 1800 further includes storing the one or more LUTs per modulation order in one or more buffers of the receiver device.

In some aspects, the method 1800 further includes storing the one or more LUTs per modulation and coding scheme (MCS) in one or more buffers of the receiver device.

In some aspects, the method 1800 further includes storing the one or more LUTs per signal to noise ratio (SNR) range and per modulation order in one or more buffers of the receiver device.

In some aspects, the receiving includes receiving the packets on different resources; and storing actual SNRs corresponding to the different resources in one or more buffers of the receiver device.

In some aspects, the method 1800 further includes computing an actual SNR for at least one of: per layer, per code block (CB), or per resource block group (RBG) associated with the different resources.

In some aspects, the LLRs belong to different layers, CBs and RBGs associated with the different resources; the different layers, CBs and RBGs are associated with different LUTs; and the different LUTs store mapping of the LLRs to at least one bit signs of the LLRs.

In some aspects, the decompanding includes decompanding the each subset of companded LLRs associated with a different layer, CB or RBG using a corresponding LUT.

In some aspects, the method 1800 further includes computing an average LLR value for at least one of: a MSB or a LSB of the companded LLRs conditioned on each symbol hard decisioned (HDD); and the jointly decompanding comprises reconstructing the companded LLRs using the computed average LLR value.

In some aspects, the companding includes companding each LLR to generate at least two bits sign of each LLR.

In some aspects, the initial transmission is associated with a first set of modulation symbols; each HARQ retransmission is associated with a second set of modulation symbols; and the second set of modulation symbols is different from the first set of modulation symbols.

In some aspects, the initial transmission is associated with a first set of modulation symbols; and each HARQ retransmission is associated with the same first set of modulation symbols.

In one aspect, the method 1800, or any aspect related to it, may be performed by an apparatus, such as a communications device 1900 of FIG. 19, which includes various components operable, configured, or adapted to perform the method 1800. The communications device 1900 is described below in further detail.

Note that FIG. 18 is just one example of a method, and other methods including fewer, additional, or alternative steps are possible consistent with this disclosure.

### Example Communication Device

FIG. 19 depicts aspects of an example communications device 1900. In some aspects, communications device 1900 is a receiver device, such as user equipment (UE) (e.g., UE 104 of FIGS. 1 and 3). In some aspects, the receiver device may be a network entity (e.g., a BS 102 of FIGS. 1 and 3, or a disaggregated base station as discussed with respect to FIG. 2).

The communications device 1900 includes a processing system 1905 coupled to a transceiver 1945 (e.g., a transmitter and/or a receiver). The transceiver 1945 is configured to transmit and receive signals for the communications device 1900 via an antenna 1950, such as the various signals as described herein. The processing system 1905 may be configured to perform processing functions for the communications device 1900, including processing signals received and/or to be transmitted by the communications device 1900.

The processing system 1905 includes one or more processors 1910. In various aspects, the one or more processors 1910 may be representative of one or more of receive processor 358, transmit processor 364, TX MIMO processor 366, and/or controller/processor 380, as described with respect to FIG. 3. The one or more processors 2010 are coupled to a computer-readable medium/memory 1925 via a bus 1940. In certain aspects, the computer-readable medium/memory 1925 is configured to store instructions (e.g., computer-executable code) that when executed by the one or more processors 1910, cause the one or more processors 1910 to perform the method 1800 described with respect to FIG. 18, or any aspect related to it. Note that reference to a processor performing a function of communications device 1900 may include one or more processors 1910 performing that function of communications device 1900.

In the depicted example, the computer-readable medium/memory 1925 stores code (e.g., executable instructions), such as code for receiving (or obtaining) 1930, code for companding 1935, and code for decompanding 1936. Processing of the code for receiving 1930, the code for companding 1935, and the code for decompanding 1936 may cause the communications device 1900 to perform the method 1800 described with respect to FIG. 18, or any aspect related to it.

The one or more processors 1910 include circuitry configured to implement (e.g., execute) the code stored in the computer-readable medium/memory 1925, including circuitry such as circuitry for receiving (or obtaining) 1915, circuitry for companding 1920, and circuitry for decompanding 1921. Processing with the circuitry for receiving 1915, the circuitry for companding 1920, and the circuitry for decompanding 1921 may cause the communications device 1900 to perform the method 1800 described with respect to FIG. 18, or any aspect related to it.

Various components of the communications device 1900 may provide means for performing the method 1800 described with respect to FIG. 18, or any aspect related to it. For example, means for transmitting, sending or outputting for transmission may include transceivers 354 and/or antenna(s) 352 of the UE 104 illustrated in FIG. 3 and/or the transceiver 1945 and the antenna 1950 of the communications device 1900 in FIG. 19. Means for receiving or obtaining may include transceivers 354 and/or antenna(s) 352 of the UE 104 illustrated in FIG. 3 and/or the circuitry for receiving 1915, the code for receiving 1930, the transceiver 1945 and the antenna 1950 of the communications device 1900 in FIG. 19. Means for companding may include transceivers 354 and/or antenna(s) 352 of the UE 104 illustrated in FIG. 3 and/or the circuitry for companding 1920, the code for companding 1935, the transceiver 1945, the antenna 1950, and the processors 1910 of the communications device 1900 in FIG. 19. Means for decompanding may include transceivers 354 and/or antenna(s) 352 of the UE 104 illustrated in FIG. 3 and/or the circuitry for decompanding 1921, the code for decompanding 1936, the transceiver 1945, the antenna 1950, and the processors 1910 of the communications device 1900 in FIG. 19.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 19 is an example, and many other examples and configurations of communication device 1900 are possible.

### EXAMPLE CLAUSES

Implementation examples are described in the following numbered clauses:

Clause 1: A method for wireless communications at a receiver device, comprising: receiving packets comprising an initial transmission and at least one hybrid automatic repeat request (HARQ) retransmission; obtaining log likelihood ratios (LLRs) for the packets; companding each LLR to generate at least one bit sign of each LLR; and jointly decompanding each subset of companded LLRs that are associated with a same modulation symbol using single bit signs corresponding to the subset of companded LLRs.

Clause 2: The method of clause 1, wherein the jointly decompanding comprises reconstructing the subset of companded LLRs associated with the same modulation symbol jointly based on the single bit signs corresponding to the subset of companded LLRs.

Clause 3: The method of any one of clauses 1-2, wherein different decompanding schemes are associated with different modulation orders; the different decompanding schemes comprise at least a first decompanding scheme and a second decompanding scheme; and the different modulation orders comprise at least a first modulation order and a second modulation order.

Clause 4: The method of clause 3, further comprising jointly decompanding, using the first decompanding scheme, a first set of companded LLRs associated with the first modulation order, based on single bit signs corresponding to the first set of companded LLRs.

Clause 5: The method of clause 3, further comprising jointly decompanding, using the second decompanding scheme, a second set of companded LLRs associated with the second modulation order, based on single bit signs corresponding to the second set of companded LLRs.

Clause 6: The method of any one of clauses 1-5, further comprising storing the at least one bit sign corresponding to the each LLR in one or more buffers of the receiver device.

Clause 7: The method of any one of clauses 1-6, wherein each modulation symbol is mapped to one or more bits comprising at least one of a most significant bit (MSB) or a least significant bit (LSB) in accordance with a modulation scheme; computing the LLRs for the MSB and the LSB for the modulation symbol based on a transition probability matrix associated with the modulation scheme; and different transition probability matrices are associated with different modulation schemes.

Clause 8: The method of any one of clauses 1-7, further comprising mapping each bit sign to one respective LLR of the LLRs using one or more lookup tables (LUTs).

Clause 9: The method of clause 8, wherein the decompanding comprises decompanding the each subset of companded LLRs that are associated with the same modulation symbol using the one or more LUTs.

Clause 10: The method of clause 8, further comprising storing the one or more LUTs per modulation order in one or more buffers of the receiver device.

Clause 11: The method of clause 8, further comprising storing the one or more LUTs per modulation and coding scheme (MCS) in one or more buffers of the receiver device.

Clause 12: The method of clause 8, further comprising storing the one or more LUTs per signal to noise ratio (SNR) range and per modulation order in one or more buffers of the receiver device.

Clause 13: The method of any one of clauses 1-12, wherein the receiving comprises receiving the packets on different resources; and storing actual signal to noise ratios (SNRs) corresponding to the different resources in one or more buffers of the receiver device.

Clause 14: The method of clause 13, further comprising computing an actual SNR for at least one of: per layer, per code block (CB), or per resource block group (RBG) associated with the different resources.

Clause 15: The method of clause 14, wherein the LLRs belong to different layers, CBs and RBGs associated with the different resources; the different layers, CBs and RBGs are associated with different lookup tables (LUTs); and the different LUTs store mapping of the LLRs to at least one bit signs of the LLRs.

Clause 16: The method of clause 15, wherein the decompanding comprises decompanding the each subset of companded LLRs associated with a different layer, CB or RBG using a corresponding LUT.

Clause 17: The method of any one of clauses 1-16, further comprising computing an average LLR value for at least one of: a most significant bit (MSB) or a least significant bit (LSB) of the companded LLRs conditioned on each symbol hard decisioned (HDD); and the jointly decompanding comprises reconstructing the companded LLRs using the computed average LLR value.

Clause 18: The method of any one of clauses 1-17, wherein the companding comprises companding each LLR to generate at least two bits sign of each LLR.

Clause 19: The method of any one of clauses 1-18, wherein the initial transmission is associated with a first set of modulation symbols; each HARQ retransmission is associated with a second set of modulation symbols; and the second set of modulation symbols is different from the first set of modulation symbols.

Clause 20: The method of any one of clauses 1-19, wherein the initial transmission is associated with a first set of modulation symbols; and each HARQ retransmission is associated with the same first set of modulation symbols.

Clause 21: An apparatus, comprising: a memory comprising executable instructions; and one or more processors configured to execute the executable instructions and cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by one or more processors of an apparatus, cause the apparatus to perform a method in accordance with any one of Clauses 1-20.

Clause 24: A computer program product embodied on a computer-readable storage medium comprising code for performing a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a receiver device, comprising:
a memory comprising instructions; and
one or more processors configured, individually or in any combination, to execute the instructions and cause the apparatus to:
receive packets comprising an initial transmission and at least one hybrid automatic repeat request (HARQ) retransmission;
obtain log likelihood ratios (LLRs) for the packets;
compand each LLR to generate at least one bit sign of each LLR; and
jointly decompand each subset of companded LLRs that are associated with a same modulation symbol using single bit signs corresponding to the subset of companded LLRs.

2. The apparatus of claim 1, wherein the jointly decompand comprises reconstructing the subset of companded LLRs associated with the same modulation symbol jointly based on the single bit signs corresponding to the subset of companded LLRs.

3. The apparatus of claim 1, wherein:
different decompanding schemes are associated with different modulation orders;
the different decompanding schemes comprise at least a first decompanding scheme and a second decompanding scheme; and
the different modulation orders comprise at least a first modulation order and a second modulation order.

4. The apparatus of claim 3, wherein the one or more processors are configured, individually or in any combination, to execute the instructions and cause the apparatus to jointly decompand, using the first decompanding scheme, a first set of companded LLRs associated with the first modulation order, based on single bit signs corresponding to the first set of companded LLRs.

5. The apparatus of claim 3, wherein the one or more processors are configured, individually or in any combination, to execute the instructions and cause the apparatus to jointly decompand, using the second decompanding scheme, a second set of companded LLRs associated with the second modulation order, based on single bit signs corresponding to the second set of companded LLRs.

6. The apparatus of claim 1, wherein the one or more processors are configured, individually or in any combination, to execute the instructions and cause the apparatus to store the at least one bit sign corresponding to the each LLR in one or more buffers of the receiver device.

7. The apparatus of claim 1, wherein:
each modulation symbol is mapped to one or more bits comprising at least one of a most significant bit (MSB) or a least significant bit (LSB) in accordance with a modulation scheme;
the one or more processors are configured, individually or in any combination, to execute the instructions and cause the apparatus to compute the LLRs for the MSB and the LSB for the modulation symbol based on a transition probability matrix associated with the modulation scheme; and
different transition probability matrices are associated with different modulation schemes.

8. The apparatus of claim 1, wherein the one or more processors are configured, individually or in any combination, to execute the instructions and cause the apparatus to map each bit sign to one respective LLR of the LLRs using one or more lookup tables (LUTs).

9. The apparatus of claim 8, wherein the decompand comprises decompanding the each subset of companded LLRs that are associated with the same modulation symbol using the one or more LUTs.

10. The apparatus of claim 8, wherein the one or more processors are configured, individually or in any combination, to execute the instructions and cause the apparatus to store the one or more LUTs per modulation order in one or more buffers of the receiver device.

11. The apparatus of claim 8, wherein the one or more processors are configured, individually or in any combination, to execute the instructions and cause the apparatus to store the one or more LUTs per modulation and coding scheme (MCS) in one or more buffers of the receiver device.

12. The apparatus of claim 8, wherein the one or more processors are configured, individually or in any combination, to execute the instructions and cause the apparatus to store the one or more LUTs per signal to noise ratio (SNR) range and per modulation order in one or more buffers of the receiver device.

13. The apparatus of claim 8, wherein:
the receive comprises receive the packets on different resources; and
the one or more processors are configured, individually or in any combination, to execute the instructions and cause the apparatus to store actual signal to noise ratios (SNRs) corresponding to the different resources in one or more buffers of the receiver device.

14. The apparatus of claim 13, wherein:
the one or more processors are configured, individually or in any combination, to execute the instructions and cause the apparatus to compute an actual SNR for at least one of: per layer, per code block (CB), or per resource block group (RBG) associated with the different resources;
the LLRs belong to different layers, CBs and RBGs associated with the different resources;
the different layers, CBs and RBGs are associated with different lookup tables (LUTs);
different LUTs store mapping of the LLRs to at least one bit signs of the LLRs; and
the decompand comprises decompand the each subset of companded LLRs associated with a different layer, CB or RBG using a corresponding LUT.

15. The apparatus of claim 1, wherein the one or more processors are configured, individually or in any combination, to execute the instructions and cause the apparatus to:
compute an average LLR value for at least one of: a most significant bit (MSB) or a least significant bit (LSB) of the companded LLRs conditioned on each symbol hard decisioned (HDD); and
the jointly decompand comprises reconstruct the companded LLRs using the computed average LLR value.

16. The apparatus of claim 1, wherein the compand comprises compand each LLR to generate at least two bits sign of each LLR.

17. The apparatus of claim 1, wherein:
the initial transmission is associated with a first set of modulation symbols;
each HARQ retransmission is associated with a second set of modulation symbols; and
the second set of modulation symbols is different from the first set of modulation symbols.

18. The apparatus of claim 1, wherein:
the initial transmission is associated with a first set of modulation symbols; and
each HARQ retransmission is associated with the same first set of modulation symbols.

19. A method for wireless communications at a receiver device, comprising:
receiving packets comprising an initial transmission and at least one hybrid automatic repeat request (HARQ) retransmission;
obtaining log likelihood ratios (LLRs) for the packets;
companding each LLR to generate at least one bit sign of each LLR; and
jointly decompanding each subset of companded LLRs that are associated with a same modulation symbol using single bit signs corresponding to the subset of companded LLRs.

20. A non-transitory computer-readable medium comprising computer-executable instructions that, when executed by one or more processors of a receiver device, cause the receiver device to perform a method of wireless communications, comprising:
receiving packets comprising an initial transmission and at least one hybrid automatic repeat request (HARQ) retransmission;
obtaining log likelihood ratios (LLRs) for the packets;
companding each LLR to generate at least one bit sign of each LLR; and
jointly decompanding each subset of companded LLRs that are associated with a same modulation symbol using single bit signs corresponding to the subset of companded LLRs.
